(19) United States
(12) Patent Application Publication
(10) Pub. No.: US 2020/0175406 A1
(43) Pub. Date: Jun. 4, 2020

(54) APPARATUS AND METHODS FOR USING BAYESIAN PROGRAM LEARNING FOR EFFICIENT AND RELIABLE KNOWLEDGE REASONING

(71) Applicant: Silot Pte. Ltd., Singapore (SG)

(72) Inventors: Zihao SONG, Singapore (SG); Bin GU, Singapore (SG); Wei SHI, Singapore (SG)

(73) Assignee: Silot Pte. Ltd., Singapore (SG)

(21) Appl. No.: 16/561,678

(22) Filed: Sep. 5, 2019

(30) Foreign Application Priority Data
Nov. 30, 2018 (SG) 10201810742Q

(51) Int. Cl. G06N 7/00; G06N 5/02; G06N 20/00

(52) U.S. Cl. CPC G06N 7/005; G06N 20/00; G06N 5/022

(57) ABSTRACT

In some embodiments, an apparatus includes a memory and a processor operatively coupled to the memory. The processor can be configured to receive a knowledge graph data structure, the knowledge graph data structure including at least an association of a first entity record from an entity dataset with a second entity record from the entity dataset. The processor can be configured to train a Bayesian Program Learning (BPL) model that generates multiple hypotheses based on the entity dataset and the knowledge graph data structure. The processor can be configured to generate, using the BPL model, at least one hypothesis in response to input data associated with an entity. The processor can be configured to receive feedback on the at least one hypothesis. The processor can be configured to further train the BPL model based on the feedback.

### CROSS REFERENCE TO RELATED APPLICATION

This application claims priority to and the benefit of Singapore Patent Application No. 10201810742Q, filed Nov. 30, 2018 and titled “Apparatus and Methods for Using Bayesian Program Learning for Efficient and Reliable Knowledge Reasoning,” which is incorporated herein by reference in its entirety.

### TECHNICAL FIELD

The present disclosure generally relates to the field of information technology, and in particular to methods and apparatus for using Bayesian program learning for efficient and reliable knowledge reasoning.

### BACKGROUND

Knowledge reasoning is the process of making sensible hypotheses based on a knowledge representation, also referred to herein as “knowledge graph data structure”. A knowledge graph data structure is a data model that encodes what is known about the world, a domain of knowledge, and/or a field of expertise. Knowledge reasoning uses knowledge represented in a knowledge graph data structure to generate new knowledge, validate the new knowledge based on a real-world feedback, and update the known knowledge.

Some known early knowledge reasoning systems (e.g., Prolog systems) are deductive systems that require experts to handcraft logic into programs that search for exact results given certain constraints. This approach generates correct results when information about the target domain is perfect. Such an approach, however, doesn't work well when the information is imperfect. Moreover, such known systems cannot adapt to new data streams as the data is continuously received.

Some known inductive systems use data-driven methods to learn statistical patterns from data. Such inductive systems generate approximate results. Such known systems, however, can be inefficient because they require a large amount of data to train a model with reasonable accuracy. Such a requirement for a large amount of data can be costly in many applications. Moreover, such known systems are not reliable in complex, changing domains because they are prone to overfitting the training data, and the training data does not always capture a realistic population of a problem at hand.

Thus, a need exists for improved methods and apparatus, to overcome the aforementioned efficiency and reliability limitations in known knowledge reasoning methods.

### SUMMARY

In some embodiments, a method includes identifying multiple facts based on a knowledge graph data structure that represents first multiple data records and second multiple data records. Each data record from the first multiple data records is associated with an entity from multiple entities. The second multiple data records indicates multiple relationships associated with the first multiple data records. The method further includes inferring multiple beliefs from the multiple facts using a set of inference criteria, to train a first Bayesian Program Learning (BPL) model having a first set of parameters. The method further includes generating multiple hypotheses from the multiple facts and the multiple beliefs using a set of generation criteria, to train a second BPL model having a second set of parameters. The method further includes generating at least one hypothesis in response to input data associated with an entity using the first BPL model and the second BPL model. The method further includes updating the first set of parameters and the second set of parameters based on the at least one hypothesis.

### BRIEF DESCRIPTION OF THE DRAWINGS

FIG. 1 is a schematic block diagram of a system to perform knowledge reasoning, according to an embodiment.

FIG. 2 is a diagram illustrating a method of knowledge reasoning using a knowledge graph data structure, according to an embodiment.

FIG. 3 is a flowchart illustrating a method for knowledge reasoning, according to an embodiment.

FIG. 4 is a diagram showing an example output from an inference program, according to an embodiment.

FIG. 5 is a diagram showing an example output from a generation program, according to an embodiment.

FIG. 6 is a diagram showing a system architecture for knowledge reasoning, according to an embodiment.

FIG. 7 is a diagram showing a system architecture for knowledge reasoning, according to an embodiment.

### DETAILED DESCRIPTION

In some embodiments, a method includes identifying multiple facts based on a knowledge graph data structure that represents first multiple data records and second multiple data records. Each data record from the first multiple data records is associated with an entity from multiple entities. The second multiple data records indicates multiple relationships associated with the first multiple data records. The method further includes inferring multiple beliefs from the multiple facts using a set of inference criteria, to train a first Bayesian Program Learning (BPL) model having a first set of parameters. The method further includes generating multiple hypotheses from the multiple facts and the multiple beliefs using a set of generation criteria, to train a second BPL model having a second set of parameters. The method further includes generating at least one hypothesis in response to input data associated with an entity using the first BPL model and the second BPL model. The method further includes updating the first set of parameters and the second set of parameters based on the at least one hypothesis.

In some embodiments, an apparatus includes a memory and a processor operatively coupled to the memory. The processor can be configured to receive a knowledge graph data structure. The knowledge graph data structure includes at least an association of a first entity record from an entity dataset with a second entity record from the entity dataset. The processor can be configured to train a Bayesian Program Learning (BPL) model that generates multiple hypotheses based on the entity dataset and the knowledge graph data structure. The multiple hypotheses can follow a sigmoid function. The processor can be configured to generate, using the BPL model, at least one hypothesis in response to input data associated with an entity. The processor can be configured to receive feedback on the at least one hypothesis. The processor can be configured to further train the BPL model based on the feedback.

In some embodiments, a non-transitory processor-readable medium stores code representing instructions to be executed by a processor. The code includes code to cause the processor to define multiple facts based on a knowledge graph data structure that represents first multiple data records and second multiple data records. The first multiple data records are associated with multiple entities and the second multiple data records associated with multiple relationships. The multiple relationships are associated with the first multiple data records. The code includes code to cause the processor to infer a plurality of beliefs from the multiple facts using a set of inference criteria, to train a first BPL model having a first set of parameters. The code includes code to cause the processor to generate multiple hypotheses from the multiple facts and the multiple beliefs using a set of generation criteria, to train a second BPL model having a second set of parameters. The code includes code to cause the processor to detect at least one of a new fact, a new belief, or a new hypothesis. The code includes code to cause the processor to improve at least one of the first BPL model or the second BPL model based on at least one of the new fact, the new belief, or the new hypothesis.

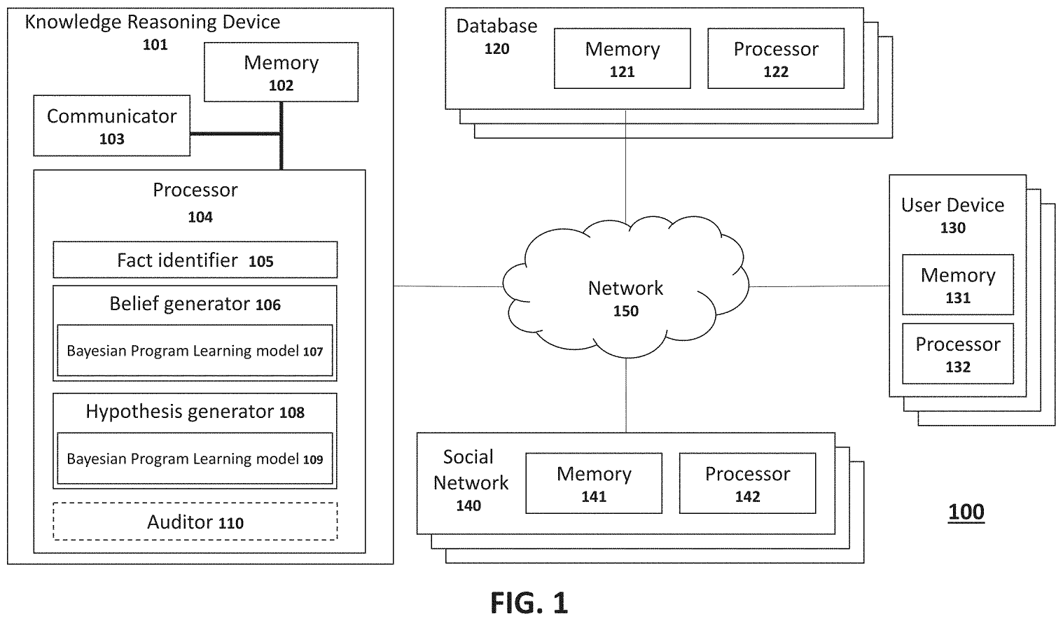

While the methods and apparatus are described herein as processing data from a knowledge graph data structure, in some instances a knowledge reasoning device, such as the knowledge reasoning device 101 of FIG. 1, can be used with a knowledge generation device, such as the knowledge generation device shown and described in U.S. patent application Ser. No. 16/543,186, filed Aug. 16, 2019, and titled “Apparatus and Methods for using Bayesian Program Learning for Efficient and Reliable Generation of Knowledge Graph Data Structures”, the disclosure of which is hereby incorporated by reference in its entirety. Therefore, the knowledge reasoning device 101 can be used to process or generate any collection or stream of artifacts, events, objects, and/or data. As an example, the knowledge reasoning device 101 can process and/or generate an artifact such as, for example, any string(s), number(s), name(s), address(es), telephone number(s), bank account number(s), social security number(s), email address(es), occupation(s), image(s), audio(s), video(s), portable executable file(s), dataset(s), Uniform Resource Locator (URL), device(s), device behavior, and/or user behavior. For further examples, an artifact can include a function of software code, a webpage(s), a data file(s), a model file(s), a source file(s), a script(s), a process, a binary executable file(s), a table(s) in a database system, a development deliverable(s), an active content(s), a word-processing document(s), an e-mail message(s), a text message, a bank account information, a handwritten form(s), and/or the like. As another example, a knowledge reasoning device 101 can process streams including, for example, a video data stream(s), an image data stream(s), an audio data stream(s), a textual data stream(s), and/or the like.

FIG. 1 is a schematic block diagram of a knowledge reasoning device 101 connected to databases 120, user devices 130, and social networks 140, and used to generate a set of BPL models to perform knowledge reasoning based on a knowledge graph data structure, according to an embodiment. The knowledge graph data structure and/or information within the knowledge graph data structure can be received from a set of data sources, including a file system, an application, a database 120, a user device 130, or a social network 140, and/or the like. In some instances, the knowledge graph data structure can also be generated based on a set of data records stored at the knowledge reasoning device 101. The set of data records can include at least one of structured data, semi-structured data, or unstructured data. In such instances, the set of data records can be received from the set of data sources. The set of data records can include image data, video data, audio data, textual data, time series data, and/or the like. In some instances, the knowledge graph data structure can received from a knowledge generation device (not shown in FIG. 1) or can be constructed by a knowledge generator (not shown in FIG. 1) at the knowledge reasoning device 101.

The knowledge reasoning device 101, also referred to herein as “the reasoning device” or “the device”, can be a hardware-based computing device and/or a multimedia device, such as for example, a compute device, a server, a desktop compute device, a smartphone, a tablet, a wearable device, a laptop and/or the like. The knowledge reasoning device 101 includes a memory 102, a communicator 103, and a processor 104.

The processor 104 can be, for example, a hardware based integrated circuit (IC) or any other suitable processing device configured to run and/or execute a set of instructions or code. For example, the processor 104 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 104 is operatively coupled to the memory 102 through a system bus (for example, address bus, data bus and/or control bus).

The processor 104 can include and/or execute a fact identifier 105, a belief generator 106, a hypothesis generator 108, and an auditor 110. Each of the fact identifier 105, the belief generator 106, the hypothesis generator 108, and the auditor 110, can be software stored in memory 102 and executed by processor 104 (for example, code to cause the processor 104 to execute the belief generator 106 and/or the hypothesis generator 108, can be stored in the memory) and/or a hardware based device such as, for example, an ASIC, an FPGA, a CPLD, a PLA, a PLC and/or the like.

The 104 processor can be configured to receive (e.g., from the memory 102 and/or other data source) a concept library (not shown in FIG. 1). The concept library can include a set of conceptual models encoded as BPL models including a set of dependencies among the conceptual models. Each conceptual model can predict a belief and/or a hypothesis. The set of conceptual models include various elements including probabilistic programs and/or uncertain parameters that can be determined empirically and by using a learning function (also referred to herein as the objective function) in the knowledge reasoning device 101. The concept library can be stored in the memory of the knowledge reasoning device 101, or be received from the set of data sources.

The fact identifier 105 can be configured to receive a knowledge graph data structure and/or a set of data records. The fact identifier 105 can be configured to identify a set of facts (e.g., name of a company, name of a person, role of the person in the company, salary of the person, etc.) from the knowledge graph data structure using a set of search functions to search the knowledge graph data structure for the set of facts based on a set of fact types (e.g., proof of income, deposit, card payment, wire transfer, etc.) and/or a set of belief types (e.g., trustworthiness, responsiveness, responsibility, fairness etc.). The set of facts can include information about a set of entities (e.g., name of a company, name of a person, salary of a person, etc.) and/or information about a set of relationships (e.g., position of the person in a company, recurring payment a person receiving from an organization, etc.) between the set of entities, in the knowledge graph data structure and/or the set of data records. The knowledge graph data structure can be generated by a knowledge generation device (not shown in FIG. 1). The fact identifier 105 can be configured further to return a set of facts.

The belief generator 106 (also referred to herein as the “inference program” or “inference model”) can be configured to receive the set of facts, a set of inference criteria, and/or the set of conceptual models of the concept library. The belief generator 106 can be configured to generate a set of beliefs (e.g., a person is popular or unpopular, an organization has a good reputation, is trustworthy, or is irresponsible, etc.). The set of inference criteria can depend on the set of beliefs (also referred to herein as ‘target beliefs’), or the set of inference criteria can depend on an existing or derived set of boundary conditions (e.g., constraints in an amount of a loan, restrictions for a credit score, and/or parameters associated with the analysis) that apply to the set of facts and/or the set of beliefs. The set of boundary conditions can include at least one of a predefined boundary condition, a dependency on a target belief, a derived boundary condition, or a restriction based on the set of fact types. The belief generator 106 can be configured to search the concept library for a set of inference models to satisfy the set of inference criteria. The set of inference models can use the set of fact types (e.g., proof of income, deposit, transaction, card payment, wire transfer, etc.) to generate a set of belief types (e.g., income, trustworthiness, responsiveness, responsibility, fairness, etc.). For example, trustworthiness is a belief type based on proof of income and the trustworthiness of transactional relationships. As another example, income is a belief type based on a number of fact types such as pay stubs and wire transfers. The belief generator 106 can be configured to include a BPL model 107 having a set of inference criteria parameters that can be trained based on the set of facts received by the belief generator 106 and the set of beliefs generated by the belief generator 106. The BPL model can then be executed to generate at least one belief based on at least one fact.

The hypothesis generator 108 (also referred to herein as the “hypothesis generation program” or “generation program”) can be configured to receive the set of facts, the set of beliefs, a set of generation criteria, and/or the set of conceptual models. The hypothesis generator 108 can be configured to generate a set of hypotheses (e.g., a risky investment, a loan of 100,000 USD with 2% interest rate, etc.). The set of generation criteria can depend on the set of hypotheses, and/or the set of generation criteria can depend on existing or derived set of boundary conditions for selection of hypotheses (e.g., constraints in amount of loan, minimum requirements for a credit score, and/or parameters associated with the analysis) that apply to the set of facts, the set of beliefs, and/or the set of hypotheses. The hypothesis generator 108 can be configured to search the concept library for a set of generation models to satisfy the set of generation criteria. The set of generation models takes a set of belief types to generate a set of hypothesis types (e.g., loan offer, investment offer, etc.). For example, a hypothesis type can be a loan offer, the generation model for this hypothesis type can include rules that make the loan offer based on proof of business, proof of income, trustworthiness, and/or the like. The hypothesis generator 108 can be configured to include a BPL model 109 having a set of generation criteria parameters that can be trained based on the set of facts and the set of beliefs received by the hypothesis generator 108 and the set of hypotheses generated by the hypothesis generator 108. The BPL model can be then executed to generate at least one hypothesis based on at least one belief, and/or at least one fact.

The BPL models 107 and 109 can be trained to perform one or more tasks. The BPL models 107 and/or 109 can be based on a Bayesian inference model or a reinforcement learning model, and can include a set of model parameters that can generate the set of beliefs and/or a set of hypotheses from the set of data records. For example, the BPL model 107 can be configured to use a set of inference model parameters to generate the set of beliefs. As another example, the BPL model 109 can be configured to use a set of generation model parameters to generate a set of hypotheses. The set of inference model parameters and the set of generation model parameters can be optimized by iteratively executing the BPL models 107 and 109 to generate the set of beliefs and the set of hypotheses, and by changing the set of inference model parameters and the generation model parameters to generate the set of beliefs and the set of hypotheses with a more accurate result relative to a learning function. Once the more accurate result reaches a preset threshold, the set of inference model parameters and/or the set of generation model parameters can be stored and/or be executed as a trained BPL model 107 and 109. The knowledge reasoning device 101, using the trained BPL models 107 and/or 109, can be configured to perform knowledge reasoning. Each hypothesis type from the set of hypothesis types can be associated with a trained BPL model 107 and/or 109.

In some embodiments, the auditor 110 can be configured to receive the set of beliefs and/or the set of hypotheses from at least one the belief generator 106, the BPL model 107, the hypothesis generator 108, or the BPL model 109. In some embodiments, the auditor 110 can be configured to receive the set of beliefs and/or the set of hypotheses from at least one of the memory 102, the social networks 140, the user devices 130, or the databases 120. To audit the set of beliefs and/or the set of hypotheses, each belief from the set of beliefs and/or each hypothesis from the set of hypotheses can be displayed to users to be approved or disapproved. The users can validate each belief and/or each hypothesis by continued monitoring, and provide validation results through a feedback application programming interface (API). For example, a user can check that “John Doe has an unpaid debt” and submit a disapproval to the auditor 110, which can impact and/or disprove a belief that “John Doe is trustworthy”, generated by executing the BPL model 107, and/or can impact and/or disprove a hypothesis to “give a 1,000,000 dollars loan with 0.5% interest rate to John Doe”, generated by executing the BPL model 109. The disapproval can be submitted via compute device operatively connected to the knowledge reasoning device 101 and/or can be retrieved from a database by the knowledge reasoning device 101. Each validation result from the validation results can be associated with a hypothesis using a unique identifier. The validation results can stored in the memory 102 or provided to the user devices 130, or the databases 120. The validation results can be used as training data to further train the BPL models 107 and/or 109, to improve the accuracy and reliability of the knowledge reasoning device 101.

In some implementations, the auditor 110 can be configured to operate automatically. For example, after receiving an indication of a belief generated by the BPL model 107 that “John Doe is trustworthy”, and/or a hypothesis generated by the BPL model 109 to “give a 1,000,000 dollars loan with 0.5% interest rate to John Doe”, the auditor 110 of the knowledge reasoning device 101 can be configured to connect to a database 120 via the network 150 to detect that “John Doe has no outstanding debts”, and provide and confirm the generated belief and/or hypothesis by submitting an indication of approval to the auditor 110.

The memory 102 of the knowledge reasoning device 101 can be, for example, a random access memory (RAM), a memory buffer, a hard drive, a read-only memory (ROM), an erasable programmable read-only memory (EPROM), and/or the like. The memory 102 can store, for example, one or more software modules and/or code that can include instructions to cause the processor 104 to perform one or more processes, functions, and/or the like (e.g., the fact identifier 105, the belief generator 106, the BPL model 107, the hypothesis generator 108, the BPL model 109, the auditor 110). In some implementations, the memory 102 can be a portable memory (e.g., a flash drive, a portable hard disk, and/or the like) that can be operatively coupled to the processor 104. In some instances, the memory can be remotely operatively coupled with the knowledge reasoning device. For example, a remote database 120 and/or a social network 140 can be operatively coupled to the knowledge reasoning device 101 via a network 150.

The memory 102 can store BPL model data and a set of files. The BPL model data can be data associated with the BPL model 107 and/or the BPL model 109. The BPL model data can include data generated by the BPL model 107 and/or the BPL model 109 during knowledge reasoning (e.g., temporary variables, return addresses, and/or the like). The BPL model data can also include data used by the BPL model 107 and/or the BPL model 109 to process and/or analyze data (e.g., the knowledge graph data structure, the set of facts, the set of beliefs, the set of hypotheses, and/or other information related to the BPL model 107 and/or the BPL model 109).

The communicator 103 can be a hardware device of the knowledge reasoning device 101 operatively coupled to the processor 104, memory 102, and/or software stored in the memory 102, and the communicator 103 can executed by the processor 104. The communicator 103 can be, for example, a network interface card, a Wi-Fi™ module, a Bluetooth® module, an optical communication module, and/or any other suitable wired and/or wireless communication device. Furthermore, the communicator 103 can include a switch, a router, a hub and/or any other network device. The communicator 103 can be configured to connect the knowledge reasoning device 101 to a network 150. In some instances, the communicator 103 can be configured to connect to a communication network such as, for example, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof.

In some instances, the communicator 103 can facilitate receiving and/or transmitting a data record through a network 150. More specifically, in some implementations the communicator 103 can facilitate receiving and/or transmitting BPL model data through a network 150 from and/or to a set of user devices 130, from and/or to a set of databases 120 and/or from and/or to a set of social networks 140, each communicatively coupled via a network 150. The network 150 can be the Internet, an intranet, a local area network (LAN), a wide area network (WAN), a virtual network, any other suitable communication system and/or a combination of such networks. In some instances, received data can be processed by the processor 104 and/or stored in the memory 102 as described in further detail herein.

The set of databases 120 are databases, such as external hard drives, database cloud services, external compute devices, virtual machine images, and/or the like. The set of databases 120 each have a memory 121 and/or a processor 122. The processor 122 can be, for example, a hardware based integrated circuit (IC) or any other suitable processing device configured to run and/or execute a set of instructions or code. For example, the processor 122 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 122 is operatively coupled to the memory 121 through a system bus (for example, address bus, data bus and/or control bus). The memory 121 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The set of databases can be configured to communicate with the knowledge reasoning device 101 via a network 150.

The set of user devices 130 are compute devices, such as personal computers, laptops, smartphones, or so forth, each having a memory 131 and a processor 132. The processor 132 can be, for example, a hardware based integrated circuit (IC) or any other suitable processing device configured to run and/or execute a set of instructions or code. For example, the processor 132 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 132 is operatively coupled to the memory 131 through a system bus (for example, address bus, data bus and/or control bus). The memory 131 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The set of user devices 130 can be configured to communicate with the knowledge reasoning device 101 via a network 150.

The set of social networks 140 are servers and/or compute devices associated with social media services, such as WeChat®, Reddit®, Facebook®, YouTube®, LinkedIn®, Pinterest®, Twitter®, and/or the like. The set of social networks 140 each have a memory 141 and/or a processor 142. The processor 142 can be, for example, a hardware based integrated circuit (IC) or any other suitable processing device configured to run and/or execute a set of instructions or code. For example, the processor 142 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 142 is operatively coupled to the memory 141 through a system bus (for example, address bus, data bus and/or control bus). The memory 141 can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. The set of social networks 140 can be configured to communicate with the knowledge reasoning device 101 via a network 150.

In use, the processor 104 included in the knowledge reasoning device 101, can be configured to use the communicator 103 to retrieve a set of data records and/or a knowledge graph data structure from a set of data sources (e.g., databases 120, user devices 130, social networks 140, and/or the like) over the network 150. In other instance, the knowledge graph data structure and/or the set of data records can be stored in the memory 102. For example, in some instances, the knowledge graph data structure can be generated in the same device that performs knowledge reasoning. The knowledge reasoning device 101, can be configured further to receive a set of inference criteria, a set of generation criteria, and/or a set of conceptual models. The memory 102 can be configured to save the set of data records and/or the knowledge graph data structure. The processor 104 can be configured further to store the retrieved set of data records and/or the knowledge graph data structure to the memory 102 of the knowledge reasoning device 101.

The fact identifier 105, included in and/or executed by the processor 104, can be configured to receive the set of data records and/or the knowledge graph data structure. The fact identifier 105 can be configured further to identify a set of facts from the knowledge graph data structure. The belief generator 106, included in and/or executed by the processor 104, can be configured to receive the set of facts, the set of inference criteria, and/or the set of conceptual models. The belief generator 106 can include a first BPL model 107 including a set of inference model parameters. The belief generator 106 can be configured to train the first BPL model 107 to generate a set of beliefs and/or a set of belief types (e.g., trustworthiness, responsiveness, responsibility, fairness, etc.).

The hypothesis generator 108, included in and/or executed by the processor, can be configured to receive the set of facts, the set of beliefs, the set of belief types, the set of generation criteria, and/or the set of conceptual models. The hypothesis generator 108 can include a second BPL model 109 including a set of generation model parameters. The set of generation model parameters can include one or more activation functions. For example, an output layer of the generation model parameters can follow a sigmoid function, or in other words, be multiplied by the sigmoid function as the activation function of the output layer. As another example, the activation function used in the generation model parameters can include a tan h function, a Softmax function, a ReLU function, a Leaky ReLU function, and/or the like. The hypothesis generator 108, can be configured to train the second BPL model 109 to generate a set of hypotheses and/or a set of hypothesis types (e.g., loan offer, investment offer, etc.). The auditor 110, included in and/or executed by the processor 104, can be configured to receive the set of beliefs and/or the set of hypotheses. The auditor 110, can be configured to display the set of beliefs and/or the set of hypotheses to users to provide validation results. The validation results can be used as training data to further train the first BPL model 107 and/or the second BPL model 109, to improve the accuracy and reliability of the knowledge reasoning device 101.

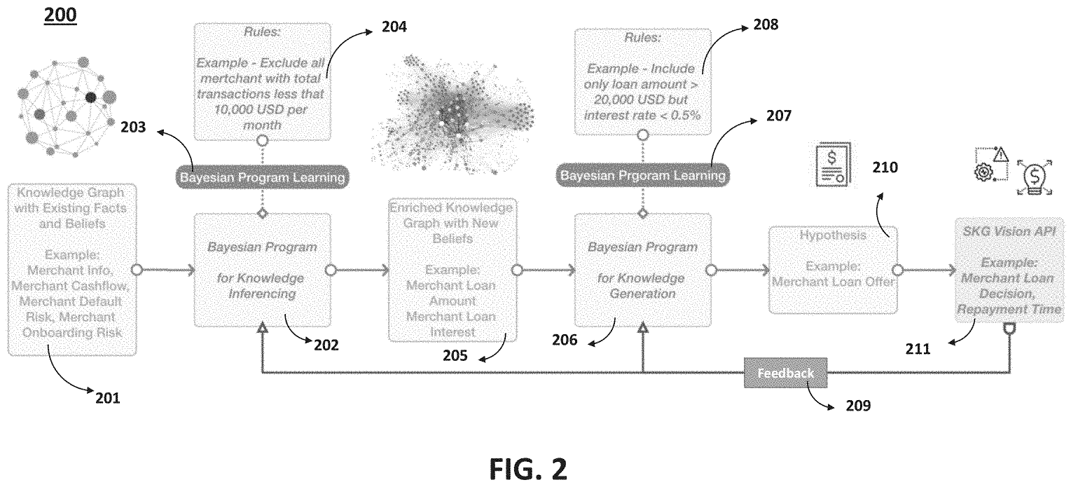

FIG. 2 is a diagram illustrating a method 200 of performing knowledge reasoning on a knowledge graph data structure, according to an embodiment. In some instances, the method 200 can be executed and/or performed by the knowledge reasoning device described above with respect to the device 101. The method 200 can include receiving a knowledge graph data structure and/or a set of data records, and identifying a set of facts including a set of entities or a set of relationships, at step 201. The method 200 can further include receiving a set of beliefs, at step 201. The method 200 can include generating a set of beliefs, at step 202, and generating a set of hypothesis, at step 206. Generating the set of beliefs, at step 202, can be performed, for example, by the belief generator 106 described above with respect to FIG. 1. Generating the set of hypotheses, at step 206, can be performed, for example, by the hypothesis generator 108 described above with respect to FIG. 1. Generating the set of beliefs, at step 202, can involve training and/or using a BPL model, at step 203, to generate the set of beliefs at step 202 and storing the beliefs with the knowledge graph data structure to define an enriched and/or updated knowledge graph data structure including the set of beliefs, at 205. The method 200 includes providing, at step 204 and via a processor, a set of inference rules. For example, generating the set of beliefs at 202 can involve receiving a set of data including indications of merchants information, indications of merchants cash-flow, indications default risk factors associated with merchants, indications of ongoing risk factors associated with merchants, and training and using a first BPL model, at step 203, to generate a list of merchants with total transactions less than 10,000 United States Dollars (USD) per month (according to the rule provided to the BPL model, at step 204). Generating the set of hypotheses 210 can involve training and/or using a second BPL model at step 207. The method 200 includes providing, at step 208 and via a processor, a set of generation rules. For example generating the set of hypotheses, at step 206, can involve receiving the enriched knowledge graph data structure, defined at step 205, and training and using a second BPL model, at step 207, to generate a hypothesis to include only loan amounts larger than 20,000 USD with interest rates less than % 0.5 (according to the rule provided to the BPL model, at 208). The method 200 can include performing a knowledge reasoning at step 211 using the outcome of the BPL model at step 203 and/or the BPL model at step 207. For example, generating hypotheses to make merchant loan decisions, or to determine merchant loan repayment time. The method 200 can further include auditing at step 209 to approve or disapprove the set of beliefs or the set of hypotheses, and further update the BPL models trained and/or executed at step 203, step 207, step 202, and/or step 206.

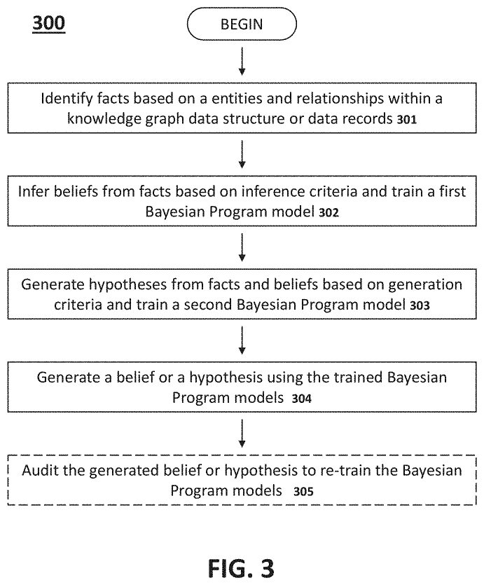

FIG. 3 is a flowchart illustrating a method 300 for performing knowledge reasoning on a knowledge graph data structure, also referred to herein as “KG”, according to an embodiment. As shown in FIG. 3, the method 300 includes identifying, at 301 and via a processor, a set of facts based on a set of entities and a set of relationships within a knowledge graph data structure or a set of data records. The method 300 includes inferring, at 302 and via a processor, a set of beliefs from the set of facts based on a set of inference criteria, and training a first BPL model. The method step 302 can be performed, for example, by an inference program or a belief generator 106 described above with respect to FIG. 1. The method 300 includes generating, at 303 and via a processor, a set of hypotheses from the set of facts and/or the set of beliefs based on a set of generation criteria, and training a second BPL model. Step 303 can be performed by a generation program or a hypothesis generator 108 described above with respect to FIG. 1. The method 300 includes executing, at 304 and via a processor, the first BPL model and/or the second BPL model to generate a belief or a hypothesis. The method 300 includes auditing, at 305 and via a processor, the belief and/or the hypothesis, to retrain the first BPL model and/or the second BPL model.

At 301, a set of facts (e.g., name of a company, name of a person, role of the person in the company, salary of the person, etc.) can be identified based on entities and relationships within a knowledge graph data structure or a set of data records. The set of facts can be associated with and/or identified from a set of entities and/or a set of relationships in the knowledge graph data structure. The set of facts can be identified using a search function to search the knowledge graph for the set of facts based on a set of fact types (e.g., proof of income, deposit, card payment, wire transfer, etc.) and/or a set of belief types (e.g., trustworthiness, responsiveness, responsibility, etc.).

At 302, a set of beliefs can be inferred from the set of facts based on a set of inference criteria, and training a first BPL model. The set of inference criteria can depend on the set of beliefs and/or on existing or derived set of boundary conditions (e.g. constraints in amount of loan, minimum requirements for a credit score, and/or parameters associated with the analysis) that are applicable to the set of facts and/or the set of beliefs. The concept library can be searched for a set of inference models to satisfy the set of inference criteria. The set of inference models receive the set of fact types (e.g., proof of income, deposit, transaction, card payment, wire transfer, etc.) to generate a set of belief types (e.g., income, trustworthiness, responsiveness, responsibility, fairness etc.). The first BPL model can be trained by iteratively generating the set of beliefs from the set of facts to train a set of inference criteria parameters. The set of beliefs can then be generated based on the set of belief types, the first BPL model, and/or the set of facts.

At 303, a set of hypotheses can be generated from the set of facts and/or the set of beliefs based on a set of generation criteria, and training a second BPL model. The set of generation criteria can depend on the set of facts, the set of beliefs, and/or the set of boundary conditions that are applicable to the set of facts, the set of beliefs, and/or the set of hypotheses. The concept library can be searched for a set of generation models to satisfy the set of generation criteria. The set of generation models receive the set of fact types and/or the set of belief types to generate a set of hypothesis type (e.g., loan offer, investment offer, etc.). The second BPL model can be trained by iteratively generating the set of hypotheses from the set of facts and/or the set of beliefs to train a set of generation criteria parameters. The set of hypotheses can then be generated based on the set of hypothesis types, the second BPL model, the set of facts, and/or the set of beliefs.

At 304, the first BPL model and/or the second BPL model can be executed to generate a belief or a hypothesis based on an input data. The input data can be an indication of request for generation of a belief and/or hypothesis. The first BPL model can be executed to generate a belief based on a fact and/or a set of facts. The fact can be received at the first BPL model via a user interface, a software interface, and/or the like. The second BPL model can then be executed to generate a hypothesis based on the belief and/or the fact. The belief and/or the hypothesis can be presented to the user, or otherwise can be stored in a memory. The stored belief and/or hypothesis can then be validated by the user.

At 305, the belief and/or the hypothesis, can be audited to re-train the first BPL model and/or the second BPL model. A user can be, for example, a human user, a software, a compute device, and/or the like. The belief and/or the hypothesis can be audited to first generate a set of validation results. The set of validation results can be analyzed to generate a binary or quantized number. The binary number can classify the belief and/or the hypothesis as ‘valid’ or ‘invalid’. Alternatively, the set of validation results can be analyzed to generate a classification, by grouping validation result with same or similar characteristic into groups. The first BPL model and/or the second BPL model can be re-trained based on the set of validation results.

To train the first BPL model and/or the second BPL model, one or more learning functions, also referred to herein as the objective functions, can be defined for the a hypothesis type. Thus, each hypothesis type can be associated with a first BPL model and/or a second BPL model. A learning function compares the output of the first BPL model and/or the second BPL model with an expected outcome to generate a prediction score for supervised learning and/or a reward for unsupervised learning, and modifies the set of inference criteria parameters and/or the set of generation criteria parameters based on the prediction score and/or the reward. In some implementations, a learning function can include and/or use:
programs and/or models selected from the concept library, inference programs and/or the generation programs,
a set of features (s={(X₁, Y₁), (X₂, Y₂), . . . , (Xₘ, Yₘ)}), the set of features can include the set of data records,
a set of actions (a={a₁, a₂, . . . , aₘ}), the set of actions can include hypotheses generated by the BPL model,
a set of rewards, (r={r₁, r₂, . . . , rₘ}), the set of rewards can be generated through feedback,
a set of learning algorithms, for example, Markov chain Monte Carlo (MCMC) or variational inference, and/or
a set of validation results.

An example of a procedure for defining the set of beliefs and the set of hypotheses from the set of facts (e.g., conducted at steps 302 and 303 of method 300 by, for example, an inference program and/or a generation program) is as follows:

Definition
Xᵢ: the i-th dataset
zᵢ: the motif of Xᵢ
Hᵢ:the set of candidates extracted from Xᵢ
Procedure of inference program and generation program

| | |
|---|---|
| s ← F_{θ}(KG) | convert KG to features, take parameter θ |
| α ← N(μ,σ) | generate parameters of inference model I |
| | assume beliefs follow Normal distribution |
| β ← S(λ) | generate parameters of generation model G |
| | assume hypotheses follow sigmoid function |
| For j = 1,...,n do | repeat n times (n: number of epochs) |

| | |
|---|---|
| For i = 1,...,m do | iterate for m samples |

| | |
|---|---|
| bᵢ ← Iₐ(Xᵢ) | calculate belief |
| αᵢ G_{β}(bᵢ) | generate action |
| rᵢ ← R(αᵢ,Yᵢ) | generate reward |

| | |
|---|---|
| r ← Σᵢ₌₁^{m} rᵢ | sum all rewards |

| | |
|---|---|
| α ← W(α \| r) | update inference model parameters |
| β ←←V(β \| r) | update generation model parameters |

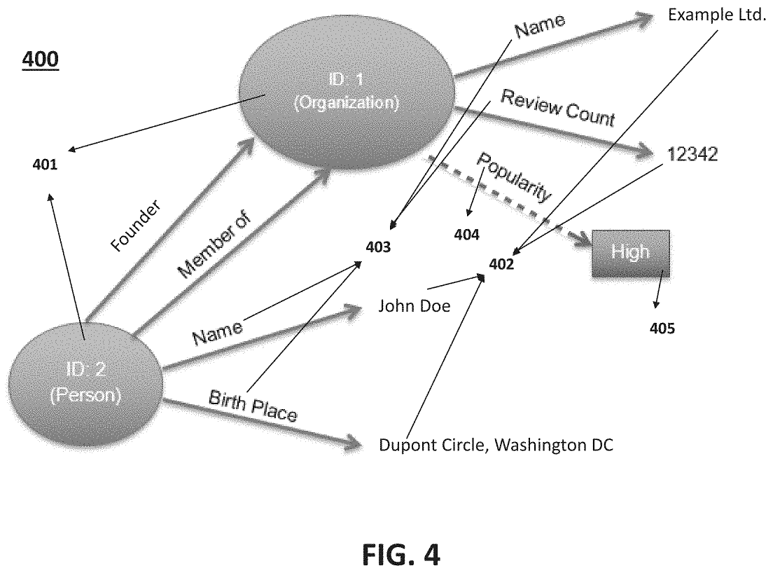

FIG. 4 is a diagram 400 showing an example output from an inference program or belief generator 106 described above with respect to FIG. 1. The diagram 400 is a knowledge graph data structure with an addition of an example of a belief 405 generated based on the knowledge graph data structure. The knowledge graph data structure can be generated and/or used by a knowledge generation device, such as the knowledge generation device shown and described in U.S. patent application Ser. No. 16/543,186, filed Aug. 16, 2019, and titled “Apparatus and Methods for using Bayesian Program Learning for Efficient and Reliable Generation of Knowledge Graph Data Structures”, the disclosure of which is hereby incorporated by reference in its entirety. The ellipsoids 401 and the solid line arrows represent an initial set of facts including a set of entities and a set of relationships. The ellipsoids 401 represent entity records that can be configured to include an identification number (e.g., 1, 2) and/or an entity type (e.g., organization, person, place, etc.). The strings 402 are attributes that are identified by using a set of motifs 403 (e.g., name, review count, birth place, and so forth) and a set of control parameters. The set of control parameters can be sampled from the set of candidates and specify the qualifying criteria for merging multiple candidates from a set of candidates. For example, the candidates 402 (also referred to as ‘attribute’ after merging into an entity) ‘Example Ltd.’ and ‘12342’ are identified using, respectively, the motifs 403 ‘Name’ and ‘Review Count’, to associate with the entity record 401 with ID of ‘1’ and an entity type ‘Organization’. A belief 405 is related to an entity 401 with a belief type 404 about the entity 401. For example, the entity ‘Organization’ 401 is identified to have a belief 405 of ‘High Popularity’ or simply ‘High’ associated with the Organization 401 via a belief type of ‘Popularity’ 404. Depending on information requested by a user device, such as the user device 130 described above with respect to the device 101, the belief generator 106 can generate a belief. For example, the user can request information about the belief type of ‘Popularity’ 404 related to an entity record ‘Organization’ 401 with an attribute of ‘Example Ltd.’ 402. The device 101 can then generate a belief 405 of ‘High’ about the ‘Popularity’ belief type 404 of ‘Example Ltd.’ attribute 402, based on the fact that ‘Organization’ entity record 401 has a ‘Review Count’ motif 403 with a ‘12342’ attribute 402.

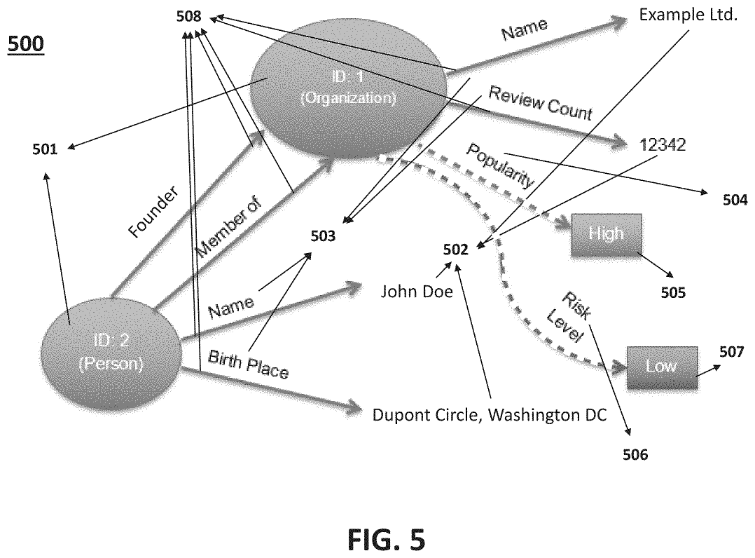

FIG. 5 is a diagram showing an example output from a generation program or hypothesis generator 108 described above with respect to FIG. 1. The diagram 500 is a knowledge graph data structure with the addition of an example of belief 505 and hypothesis 507 generated based on the knowledge graph data structure. The knowledge graph data structure can be generated and/or used by a knowledge generation device, such as the knowledge generation device shown and described in U.S. patent application Ser. No. 16/543,186, filed Aug. 16, 2019, and titled “Apparatus and Methods for using Bayesian Program Learning for Efficient and Reliable Generation of Knowledge Graph Data Structures”, the disclosure of which is hereby incorporated by reference in its entirety. The ellipsoids 501 and the arrows 508 represent an initial set of facts including a set of entities and a set of relationships. The ellipsoids 501 represent entity records that can be configured to include an identification number and/or an entity type. The rightmost strings 502 are attributes that are identified by using the set of motifs 503 and using the set of control parameters. In an example, the attributes 502 ‘John Doe’ and ‘Dupont circle, Washington D.C.’ are identified using the motifs 503 ‘Name’ and ‘Birth Place’ to merge into the entity record 501 with ID of ‘2’ and an entity type of ‘Person’. Also in the example, the attributes 502 ‘Example Ltd.’ and ‘12342’ are identified using the motifs 503 ‘Name’ and ‘Review Count’ to merge into the entity record 501 with ID of ‘1’ and an entity type of ‘Organization’. Also in the example, the entity records with the IDs of ‘1’ and ‘2’ are linked together with the relation types of ‘Founder’ and ‘Member of’. The upper rectangle represent a belief 505 that is related to an entity 501 via a belief type 504 about the entity 501. The lower rectangle represent a hypothesis 507 that is related to an entity 501 via a hypothesis type 506 about the entity 501. For example, the entity ‘Organization’ 501 is identified to have a belief 505 of ‘High Popularity’ or simply ‘High’ associated with it via a belief type of ‘Popularity’ 505. In addition, the entity ‘Organization’ 501 is identified to have a hypothesis 507 of ‘Low Risk Level’ or simply ‘Low’ associated with it via a hypothesis type of ‘Risk Level’ 506. Depending on information requested by a user device, such as the user device 130 described above with respect to the device 101, the hypothesis generator 108 can generate a hypothesis. For example, the user can request information about the hypothesis type 506 of ‘Risk Level’ related to an entity record ‘Organization’ 501 with an attribute of ‘Example Ltd.’ 502. The device 101 can then generate a hypothesis 507 of ‘Low’ about the ‘Risk Level’ belief type 506 of ‘Example Ltd.’ attribute 502, based on the fact that ‘Organization’ entity record 501 has a ‘Review Count’ motif 503 with a ‘12342’ attribute 502, based on the belief of ‘High’ about the belief type of ‘Popularity’ 504 related to the entity record ‘Organization’ 501 with the attribute of ‘Example Ltd.’ 502.

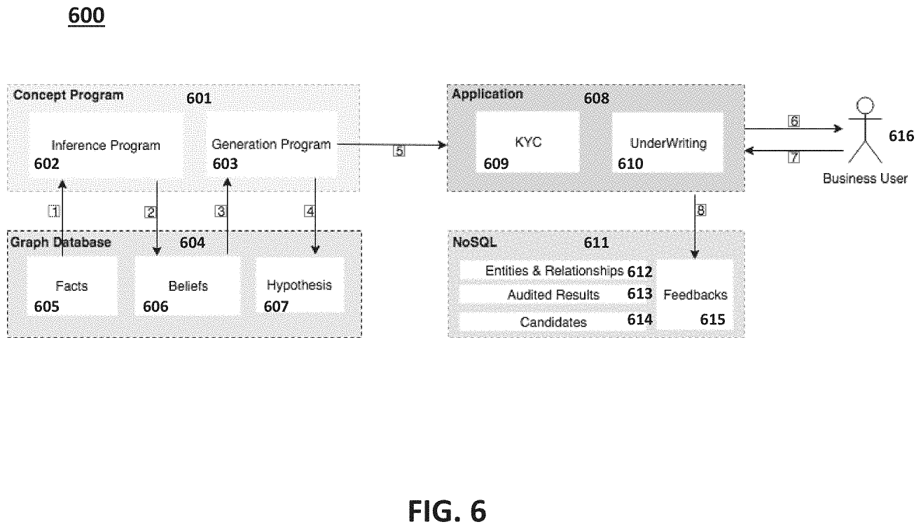

FIG. 6 is a diagram showing a system 600 for performing knowledge reasoning, according to an embodiment. The system 600 can be part of a knowledge reasoning device 101 described with respect to FIG. 1. The system 600 can be the same as or substantially similar to the knowledge reasoning device 101 described with respect to FIG. 1. For example, the system 600 can include a graph dataset 604, a concept program 601, a NoSQL 611, also referred to herein as the “entity database”, and an application 608.

The concept program 601 can include an inference program 602 and a generation program 603. The inference program 602 can be configured to receive, via step 1, a set of facts 605 stored in the graph database 604. The concept program 601 can process the set of facts 605 to generate a set of beliefs 606, at the processor 104 described with respect to FIG. 1, and then store, via step 2, the set of beliefs 606 to the graph database 604. The generation program 603 can be configured to receive, via step 3, a set of facts 605 and/or a set of beliefs 606 stored in the graph database 604. The generation program 603 can process the set of facts 605 and/or the set of beliefs 606 to generate a set of hypotheses 607, at the processor 104, and then store, via step 4, the set of hypotheses 607 to the graph database 604.

In an example use case, the set of hypotheses, the set of beliefs, and/or the set of facts can be received by an application software 608 (e.g., a bank's application software) having a Know Your Customer ‘KYC’ application 609 and/or an underwriting application 610. The KYC application 609 and/or underwriting application 610 of the application 608 can display, via step 6, the hypotheses to a business user 616. The business user 616 can be, for example, a bank clerk or software (executed by hardware in a compute device). The business user 616 can provide, via step 7, feedback to the application software 608. The feedback 615 can be stored, via step 8, by the application to a NoSQL 611. The NoSQL 611 can further include entities and relationships 612, a set of audited results 613, and a set of candidates 614. The application 608 and/or the concept program 601 can be configured to read the entities and relationships 612, a set of audited results 613, a set of candidates 614, a new fact, a new belief, a new hypothesis, and/or the like, stored in the NoSQL 611 to verify the correctness of the data in the NoSQL 611, and/or update the inference program and/or the generation program according to the data in the NoSQL 611.

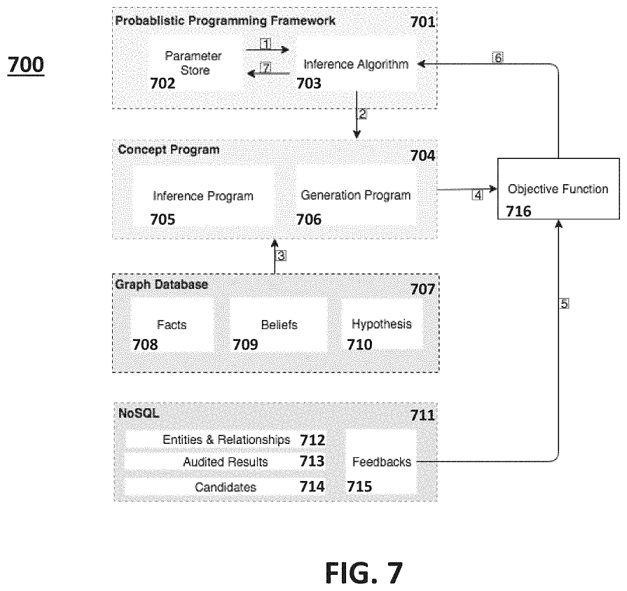

FIG. 7 is a diagram showing a system 700 for performing knowledge reasoning, according to an embodiment. The system 700 can be part of a knowledge reasoning device 101 described with respect to FIG. 1. The system 700 can be the same as or substantially similar to the knowledge reasoning device 101 described with respect to FIG. 1. For example, the system 700 can include a probabilistic programming framework 701, a concept program 704, a graph database 707, and a NoSQL 711.

In an embodiment, the probabilistic programming framework 701 can include a parameter store 702 and an inference algorithm 703. A set of model parameters can be read, via step 1, by the inference algorithm 703. The set of model parameters of the parameter store 702 can be, for example, a set of inference model parameters and/or a set of generation model parameters from at least one previously trained BPL model, such as the BPL model 107 and/or the BPL model 109 described with respect to FIG. 1. The parameter store 702 and/or the inference algorithm 703 can be stored, for example, in the memory 102 described with respect to FIG. 1. The inference algorithm can be the same as or similar to the belief generator 106 or the hypothesis generator 108 described with respect to FIG. 1, and can be configured to receive the set of model parameters from the parameter store to generate a set of beliefs and/or a set of hypotheses.

The concept program 704 can include an inference program 705 and/or a generation program 706. The concept program 704 can be triggered to be executed by the inference algorithm, at step 2. The concept program 704 can receive the set of inference model parameters and/or the set of generation model parameters from the parameter store 702 from the probabilistic programming framework 701. At step 3, the concept program 704 can be configured further to receive a set of facts 708, from the graph database 707, to generate a set of beliefs 709 and/or a set of hypotheses 710, which can be stored in the graph database 707. The generated hypotheses at the concept program 704 can be sent to an objective function 716, at step 4. The objective function 716 can be configured to receive feedback 715 corresponding to generated hypothesis stored in a NoSQL database 711, at 5; the NoSQL 711 can further include a set of entities and relationships 712, a set of audited results 713, and a set of candidates 714. A training loss can be calculated based on the set of hypotheses 710 and their corresponding feedback 715 using the objective function 716. The training loos can include, for example, a mean square error, a mean absolute error, a mean absolute percentage error, a hinge, a log cos h, a categorical crossentropy, and/or the like. The training loss can be configured to be sent to the inference algorithm 703 of the probabilistic programming framework 701, at step 6. The set of inference model parameters and/or the set of generation model parameters from the parameter store 702 can be updated and stored in the parameter store 702 based on the training loss, at step 7. Steps 1-7 of FIG. 7 can be iterated until the training loss converges to a preset threshold, or the time to process the iteration converges to a preset threshold.

Some embodiments described herein relate to methods. It should be understood that such methods can be computer implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

Some embodiments described herein relate to computer-readable medium. A computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, PLDs, ROM and RAM devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, R, Java, C++, or other programming languages (e.g., object-oriented programming languages) and development tools. Additional examples of computer code include, but are not limited to, control signals, encrypted code, and compressed code.

All combinations of the foregoing concepts and additional concepts discussed here (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. They are presented to assist in understanding and teach the embodiments.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is provided as an example and equivalents, regardless of order, are contemplated by the disclosure.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

It should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes can be made without departing from the scope of the disclosure.

1. A method, comprising:
identifying a plurality of facts based on a knowledge graph data structure that represents a first plurality of data records and a second plurality of data records, each data record from the first plurality of data records being associated with an entity from a plurality of entities, the second plurality of data records indicating a plurality of relationships associated with the first plurality of data records;
inferring a plurality of beliefs from the plurality of facts using a set of inference criteria, to train a first Bayesian Program Learning (BPL) model having a first set of parameters;
generating a plurality of hypotheses from the plurality of facts and the plurality of beliefs using a set of generation criteria, to train a second BPL model having a second set of parameters;
generating at least one hypothesis in response to input data associated with an entity using the first BPL model and the second BPL model; and
updating the first set of parameters and the second set of parameters based on the at least one hypothesis.

2. The method of claim 1, wherein the first plurality of data records and the second plurality of data records include at least one of image data, video data, audio data, textual data, or time series data.

3. The method of claim 1, wherein the first plurality of data records and the second plurality of data records are received from at least one of a database, a file system, or an application.

4. The method of claim 1, further comprising:
improving the first BPL model and the second BPL model using at least one of a Markov Chain Monte Carlo (MCMC) algorithm or a variational inference algorithm.

5. The method of claim 1, wherein at least one of the set of inference criteria or the set of generation criteria includes at least one of a dependency on a target belief, a predefined boundary condition, a derived boundary condition, or a restriction based on types of facts.

6. The method of claim 1, wherein the second BPL model is at least one of a Bayesian inference model or a reinforcement learning model.

7. The method of claim 1, further comprising:
receiving feedback on at least one hypothesis from the plurality of hypotheses; and
improving at least one of the first BPL model or the second BPL model based on the feedback.

8. An apparatus, comprising:
a memory; and
a processor operatively coupled to the memory,
the processor configured to receive a knowledge graph data structure, the knowledge graph data structure including at least an association of a first entity record from an entity dataset with a second entity record from the entity dataset,
the processor configured to train a Bayesian Program Learning (BPL) model that generates a plurality of hypotheses based on the entity dataset and the knowledge graph data structure, the plurality of hypotheses following a sigmoid function;
the processor configured to generate, using the BPL model, at least one hypothesis in response to input data associated with an entity,
the processor configured to receive feedback on the at least one hypothesis, and
the processor configured to further train the BPL model based on the feedback.

9. The apparatus of claim 8, wherein the entity dataset includes at least one of image data, video data, audio data, textual data, or time series data.

10. The apparatus of claim 8, wherein the entity dataset includes at least one of structured data, semi-structured data, or unstructured data.

11. The apparatus of claim 8, wherein the knowledge graph data structure is received from at least one of a database, a file system, or an application.

12. The apparatus of claim 8, wherein the processor is configured to improve the BPL model using at least one of a Markov Chain Monte Carlo (MCMC) algorithm or a variational inference algorithm.

13. The apparatus of claim 8, wherein the BPL model is at least one of a Bayesian inference model or a reinforcement learning model.

14. A non-transitory processor-readable medium storing code representing instructions to be executed by a processor, the code comprising code to cause the processor to:
define a plurality of facts based on a knowledge graph data structure that represents a first plurality of data records and a second plurality of data records, the first plurality of data records associated with a plurality of entities, the second plurality of data records associated with a plurality of relationships, the plurality of relationships associated with the first plurality of data records;
infer a plurality of beliefs from the plurality of facts using a set of inference criteria, to train a first Bayesian Program Learning (BPL) model having a first set of parameters;
generate a plurality of hypotheses from the plurality of facts and the plurality of beliefs using a set of generation criteria, to train a second BPL model having a second set of parameters;
detect at least one of a new fact, a new belief, or a new hypothesis; and
improve at least one of the first BPL model or the second BPL model based on at least one of the new fact, the new belief, or the new hypothesis.

15. The non-transitory processor-readable medium of claim 14, wherein the first plurality of data records and the second plurality of data records include at least one of image data, video data, audio data, textual data, or time series data.

16. The non-transitory processor-readable medium of claim 14, wherein the first plurality of data records and the second plurality of data records are received from at least one of a database, a file system, or an application.

17. The non-transitory processor-readable medium of claim 14, the code further comprising code to cause the processor to:
improve at least one of the first BPL model or the second BPL model using at least one a Markov Chain Monte Carlo (MCMC) algorithm or a variational inference algorithm.

18. The non-transitory processor-readable medium of claim 14, the code further comprising code to cause the processor to:
receive feedback on at least one hypothesis from the plurality of hypotheses; and
improve at least one of the first BPL model or the second BPL model based on the feedback.

19. The non-transitory processor-readable medium of claim 14, wherein at least one of the set of inference criteria or the set of generation criteria include at least one of a dependency on a target belief, a predefined boundary condition, a derived boundary condition, or a restriction based on types of facts.

20. The non-transitory processor-readable medium of claim 14, wherein the second BPL model is at least one of a Bayesian inference model or a reinforcement learning model.
